(19) United States
(12) Patent Application Publication
(10) Pub. No.: US 2018/0216815 A1
(43) Pub. Date: Aug. 2, 2018

(54) HEAT EXCHANGER

(71) Applicant: SERMETA, Morlaix (FR)

(72) Inventor: Joseph LE MER, Plouezoch (FR)

(21) Appl. No.: 15/881,607

(22) Filed: Jan. 26, 2018

(30) Foreign Application Priority Data
Jan. 27, 2017 (FR) 1750698

(51) Int. Cl. F23C 5/02; F23C 3/00; F23D 99/00; F27D 1/18

(52) U.S. Cl. CPC F23C 5/02; F23C 3/002; F27D 2201/00; F27D 1/1808; F27D 2001/1825; F23D 91/04

(57) ABSTRACT

The invention relates to a heat exchanger (1) comprising a shell (2) containing a heat exchange device (3) and delimiting a combustion chamber (30), said shell (2) being provided with an access opening and with a door (5) provided on its inner face with a burner (4).

It is remarkable in that said door (5) is mounted pivotally around a pivot (6) attached to the end of a slide (7), in that said shell (2) is provided on its exterior surface with axial guide means (8) of said slide (7) along a displacement axis X2-X′2 which extends parallel to the longitudinal axis X-X′ of said shell (2), in that the pivot (6) extends along an axis Z-Z′ perpendicular to said displacement axis X2-X′2, the travel of said slide (7) being greater than the length of the burner (4).

### GENERAL TECHNICAL FIELD

The invention is situated in the field of heat exchangers, particularly for a gas- or fuel oil-fired boiler.

The present invention relates more precisely to a heat exchanger comprising a gas-tight shell containing a heat exchange device and delimiting a combustion chamber, said shell being provided with an access opening and with a door suitable for being able to close said access opening, said door being provided with a burner, particularly for gas or fuel oil, protruding from its inner face.

### PRIOR ART

Also known already from document FR2942866 is a heat exchanger as previously mentioned. Its door is also provided on its outer face with a system for bringing a combustible mixture to the burner. Finally, said shell is provided with a sleeve for discharging the burned gasses.

This door is attached detachably to a framework for said access opening, for example by means of screws.

However, it is necessary to regularly gain access to the tubes of the exchanger and/or to the burner for maintenance operations.

The opening of the door is carried out by withdrawing it after unscrewing the screws. This removal must sometimes be carried out using a hoist if this door is bulky and/or heavy, which is the case in particular for high-powered heat exchangers in which the door can attain a diameter of 1 meter and a weight of over 50 kg.

Also know in the prior art are heat exchangers in which the door is mounted on a hinge attached to the face of the exchanger. However, such a door can only be equipped with a small-sized burner, because a bulkier burner would block the pivoting movement of the door.

### PRESENTATION OF THE INVENTION

The invention has as its aim resolving the aforementioned disadvantages of the prior art and proposing a heat exchanger equipped with an access door equipped with a burner, which allows total and facilitated access both to the burner and to the heat exchange devices, while still avoiding lifting the door, either manually or with a hoist.

The invention must also allow maintaining the gas-tightness of the exchanger when the door is again closed against its face.

To this end, the invention relates to a heat exchanger comprising a gas-tight shell containing a heat exchange device and delimiting a combustion chamber, said shell being provided with an access opening and with a door suitable for being able to close said access opening, said door being provided with a burner, particularly for gas or for fuel oil, protruding from its inner face. According to the invention, said door is mounted pivotally around a pivot attached to the so-called “front” end of a slide, or substantially to this front end said shell is provided on its exterior surface with guide means which allow said slide to be guided axially along a displacement axis X2-X′2 which extends parallel to the longitudinal axis X-X′ of said shell, the pivot extends along an axis Z-Z′ perpendicular to said displacement axis X2-X′2, and the travel of said slide is greater than the length of the burner, so that said door can be moved from a closed position, in which it closes the access opening of said shell, to a so-called “spaced-apart” position, in which it is separated from this access opening and in which the burner is located outside the shell, and said door being able to pivot around the pivot when it is located in said “separated” position.

Thanks to these features of the invention, the burner can be completely withdrawn from the exchanger, which facilitates its cleaning and possible interventions on the insulator that surrounds it. Moreover, the door remains attached to the slide and is supported by it. It is therefore no longer necessary to lift it.

Finally, in the closed position of the door, the gas-tightness of the exchanger is guaranteed.

According to other advantageous and non-limiting features of the invention, taken alone or in combination:
the door can pivot around the pivot at an angle of at least 180°;
the slide is provided with an end-of-travel stop which prevents it from leaving the guide means;
the slide is a strip having an upper face and a lower face and the guide means comprise two upper rotating rollers and two lower rotating rollers in the shape of twin wheels, mounted as idlers, provided with a groove the profile of which corresponds to that of said upper and lower faces of the slide;
the upper face and the lower face of the slide have the shape of a protruding V with two facets;
a plate is attached to the outer face of the door and has two protruding flanks which extend in a plane perpendicular to the axis Z-Z′ of the pivot, each flank being perforated with an aperture, the pivot having a blind hole at each of its two ends and a shoulder screw being screwed into each blind hole through the aperture provided in the flank, so as to allow the pivoting of the door around the pivot;
said door is provided with blocking means preventing its pivoting around the pivot with respect to said slide and holding it in a position where it is perpendicular to the displacement axis of said slide;
the slide is provided at its front end with a port passing through it from side to side, the door having at its periphery, on its face situated facing the pivot, a blind hole and said blocking means comprising a removable pin configured to be able to be inserted through said port, into said blind hole, thus blocking the pivoting movement of the door with respect to the slide;
the door is provided with at least one handle on its outer face;

### PRESENTATION OF THE FIGURES

Other features and advantages of the invention will appear from the description which will now be made, with reference to the appended drawings which represent, indicatively but without limitation, a possible embodiment of it.

In these drawings:

FIG. 1 is a perspective view of an exemplary embodiment of the heat exchanger conforming to the invention,

FIGS. 2 to 5 are perspective views of the exchanger of FIG. 1, showing the opening and closing kinematics of the door of this exchanger, and

FIG. 6 is a vertical section view of a portion of the exchanger, taken along the section plane represented by line VI-VI in FIG. 1.

### DETAILED DESCRIPTION

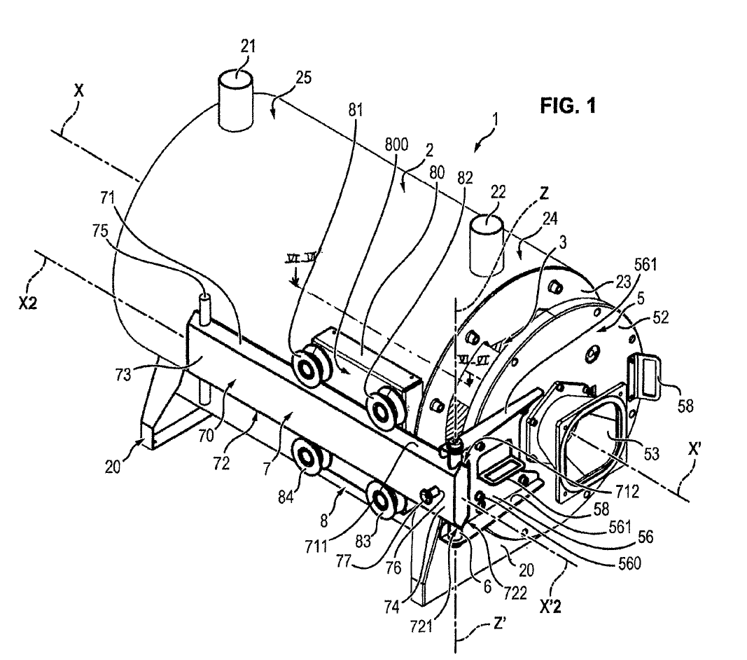

Referring back to FIG. 1, it can be seen that the heat exchanger 1 conforming to the invention comprises a gas-tight shell 2. This rests for example on legs 20.

In the rest of the description and of the claims, references to the terms “horizontal” or vertical will be taken into consideration with respect to the position of the exchanger 1 in FIGS. 1 to 5.

The shell 2 contains a heat exchange device 3 allowing a fluid, for example cold water, to be heated.

In the figures, reference symbols 21 and 22 correspond to the inlet and outlet apertures of the device 3 of the heat exchanger.

The shape of the shell 2 is immaterial (indifferent). It has a longitudinal axis X-X′. In the example shown in the figures, this shell 2 is cylindrical. It also has a burnt gas discharge sleeve, not visible in the figures.

The shell 2 has a face 23 which delimits an opening 230 for access to the interior of said shell. By convention, the end of the shell 2 situated in proximity to the face 23 is called the front end 24 and its opposite end, the rear end 25.

The shell 2 also comprises a door 5 designed to close the opening 230 provided in the face 23.

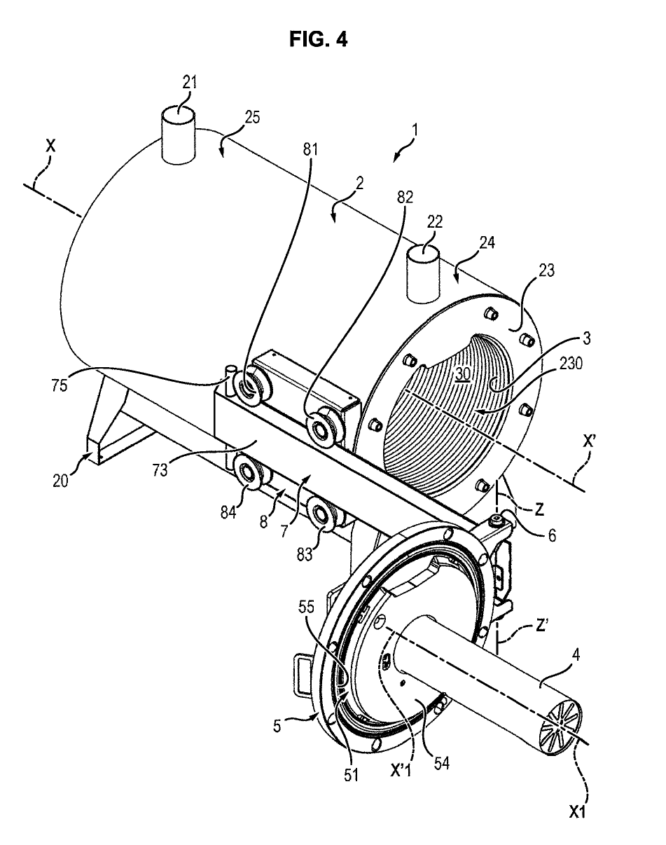

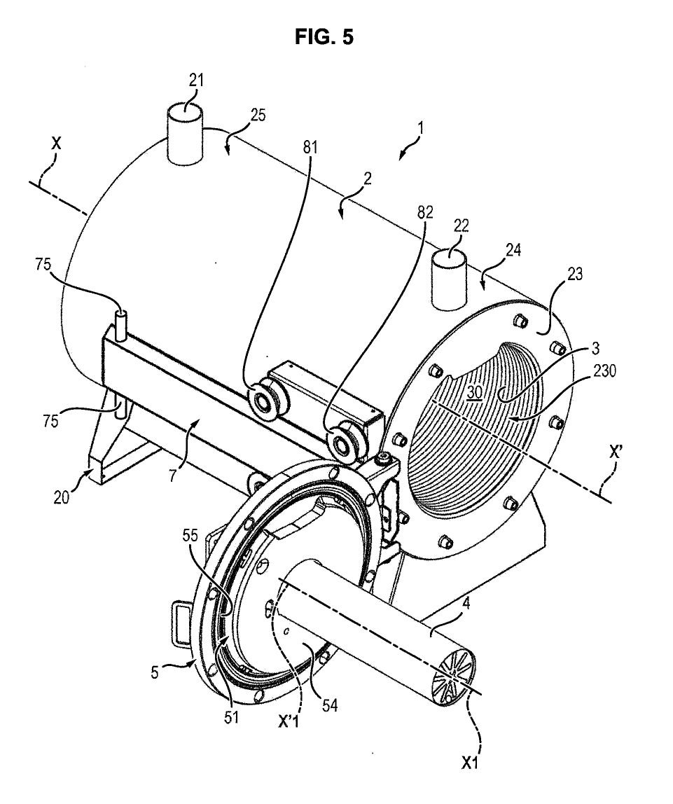

A burner 4 is attached to the central portion of the door, on its inner face 51, from which it protrudes. The inner face 51 of the door 5 of the shell 2 is the face oriented towards the inside of the shell 2 when the door 5 is closed. Thus, when the door 5 is closed, the burner 4 is positioned in proximity to the heat exchange device 3. The shell 2 delimits a combustion chamber 30 (see FIGS. 4 and 5).

Advantageously, but not compulsorily, the burner 4 is cylindrical, with longitudinal axis X1-X′1. Also preferably, this longitudinal axis X1-X1 is coaxial with the longitudinal axis X-X′ of the shell 2.

The burner 4 preferably uses gas or fuel oil.

The combustion gases generated by this burner 4 accomplish the heating of the fluid contained in the heat exchange devices 3.

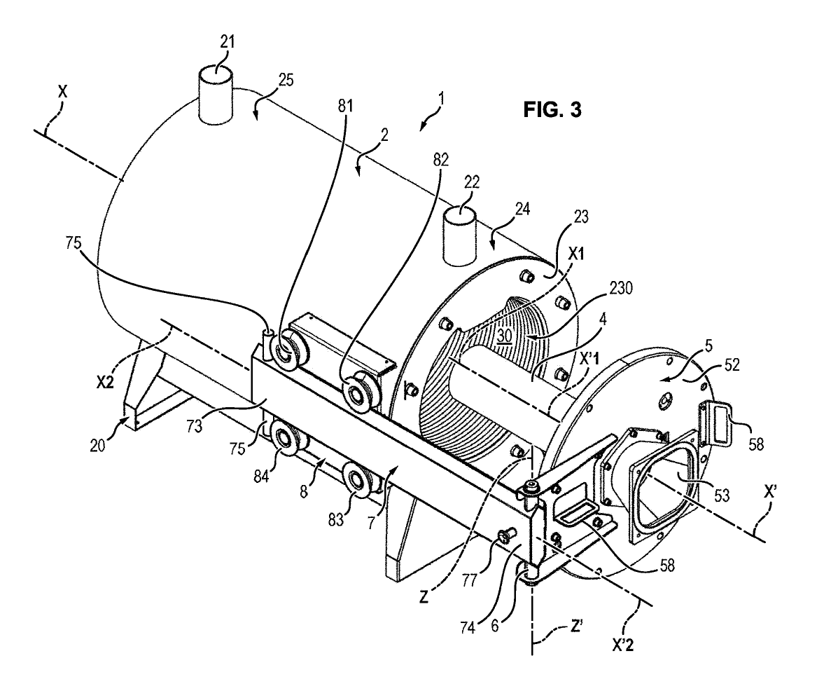

As can be seen in FIG. 3 for example, the outer face 52 of the door 5 is preferably connected to a sleeve 53 for supplying a combustible gas mixture (gas, fuel/air or fuel oil/air for example), and the transfer of this mixture to the burner 4 is accomplished through an appropriate opening provided in the door 5.

As is more clearly visible in FIGS. 4 and 5, the zone of the inner face 51 of the door 5 which surrounds the burner 4 is advantageously covered with a heat-resisting and thermally insulating material 54 and a seal 55.

The door 5 is mounted pivotally around a pivot 6, itself supported by and attached to the end, or substantially to the end of a slide 7. Said slide 7 is guided and mounted sliding with respect to the guide means 8 provided on the outer face of the shell 2.

According to one possible embodiment, the door 5 is equipped with a plate 56 attached, for example by means of screws 560, to the outer face 52 of the door. This plate could also be an integral part of the door, if the latter were cast for example.

The slide 7 is a planar rectilinear strip of low thickness having, as can be seen in FIG. 1, an exterior vertical face 70, an upper face 71, an opposite lower face 72, a rear end 73 and a front end 74.

Preferably, the upper face 71 and the lower face 72 each have in cross-section, a V shape of which the point protrudes toward the outside; in other words, they have two facets 711, 712, respectively 721, 722.

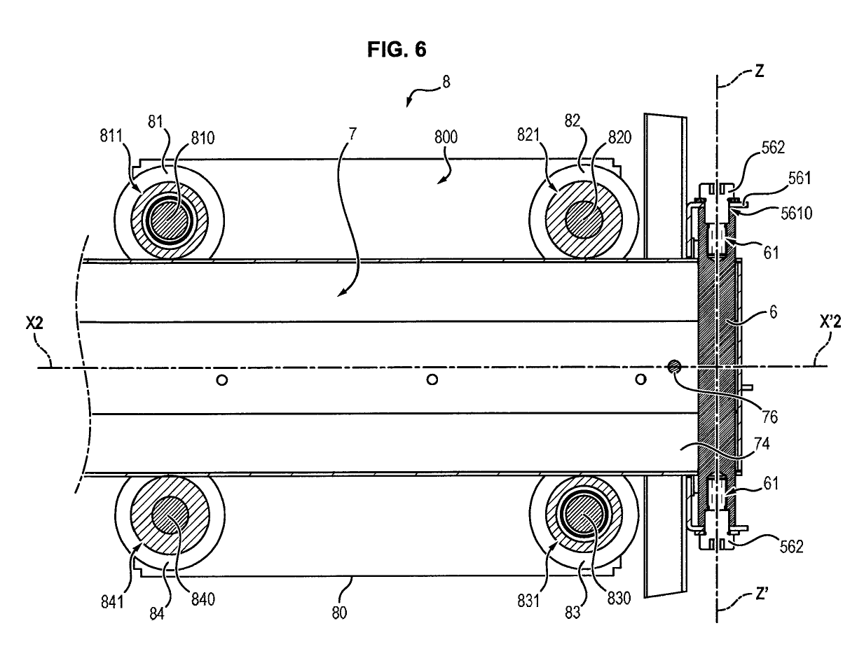

As appears more clearly on the section view of FIG. 6, the pivot 6 is attached, for example by welding, through the front end 74 of the slide 7.

The pivot 6 extends along a vertical axis Z-Z′ perpendicular to the longitudinal axis X2-X′2 of the slide 7.

The pivot 6 has a blind tapped hole 61 at each of its two ends.

The two sides, top and bottom, of the plate 56 are curved horizontally forward to form two flanks 561 extending in a plane perpendicular to the axis Z-Z′. Each flank 561 is perforated with an aperture 5610. The two apertures 5610 are aligned vertically and each leads into a position facing one of the blind holes 61 of the pivot 6.

A shoulder screw 562 is screwed into each blind hole 61 through an aperture 5610, with a clearance allowing the pivoting of the plate 56 and therefore of the door 5 to which it is attached, around the pivot 6. This pivoting can be accomplished through an angle of at least 180°.

According to a possible embodiment of the invention, the guide means 8 comprises a plate 80 and four rollers, respectively two rear 81 and front 82 upper rollers and two front 83 and rear 84 lower rollers (see FIGS. 1 and 6).

The plate 80 is attached, by welding for example, to the exterior face of the shell 2. It has a flat exterior face 800.

The rotating rollers 81 to 84 are mounted as idlers around axes of rotation, respectively 810, 820, 830 and 840, themselves attached to the exterior face 800 of said plate 80.

The axes 810 to 840 are orthogonal to the longitudinal axis X-X′ of the shell 2.

The rollers 81 to 84 are for example rollers in the shape of twin wheels (diabolo shape) having at their periphery an annular groove respectively 811, 821, 831 and 841, the shape of which cooperates with that of the upper 71 and lower 72 surfaces of the slide 7. The two-faceted shape of these faces facilitates self-centering of the slide 7 with respect to the rollers.

The slide 7 is thus guided axially by the guide means 8 along a displacement axis X2-X′2, which is congruent with the longitudinal axis X2-X′2 of the slide 7 and which is moreover parallel to the longitudinal axis X-X′ of the shell 2.

Advantageously, two of the diagonally opposite rollers, here for example the rollers 81 and 83, are disposed on the plate 80 so as to be aligned on the slide 7, and to facilitate their rolling on the latter. Conversely, the two other rollers situated on the opposite diagonal, here for example the rollers 82 and 84, are disposed on the plate 80 so as to have a slight clearance with respect to the slide 7, which allows movement of the slide 7 but prevents jamming caused by dimensional dispersion or the geometry and the assembly of the different parts of the system.

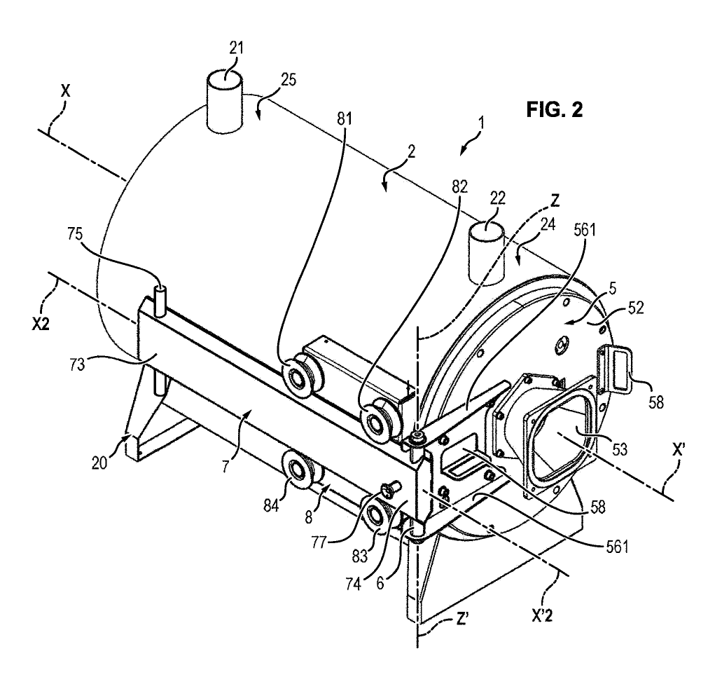

The slide 7 is thus guided axially along the displacement axis X2-X′2 and this, in the two opposite directions, so that it can move along a given path, between an extreme position called “retracted,” illustrated in FIG. 2, in which its rear end 73 is near the rear end 25 of the shell 2 and an opposite extreme position called “extended,” shown in FIGS. 3 and 4, in which its rear end 73 is moved in the direction of the guide means 8.

Advantageously, the rear end 73 of the slide 7 has a rear stop, shown here in the shape of two protruding fingers 75 extending parallel to the axis Z-Z′ of the pivot 6. This stop 75 limits the forward travel of the slide 7 and avoids its complete disengagement from the guide means 8 when it is located in the “extended” position.

The slide 7 is dimensioned and guided so that its travel along the axis X2-X′2 is greater than the length of the burner 4, so as to allow the total extraction of this burner from the shell 2.

Finally, it will be noted that the slide 7 cannot slide out of the rollers 81 to 84 to the rear due to the presence of the pivot 6 which serves as a stop.

Also advantageously, the front end 74 of the slide 7 is provided with a port 76 perpendicular to the axis X2-X2 and orthogonal to the axis Z-Z′ of the pivot 6. This port 76 passes through the slide 7 from side to side. In addition, the door 5 has at its periphery, on its face situated facing the pivot 6, a blind hole (not visible in the figures) situated in the continuation of the port 76 when the door 5 is in the closed position. A removable pin 77 can be inserted into the port 76 and into the blind hole of the door 5 facing the port 76 so as to hold the door 5 blocked in the position perpendicular to the slide 7 during the movement of the latter.

In the closed position of the door 5, gas-tightness must be ensured. To this end, the door 5 is advantageously screwed to the face 23.

Advantageously, the door 5 is also provided with one or more handle(s) 58 allowing its handling, which are attached to its outer face 52. The kinematics of opening and closure of the door 5 will now be described in connection with FIGS. 2 to 5.

FIG. 2 shows the operating position of the heat exchanger 1, in which the burner 4 is active and heats the fluid circulating in the heat exchange device 3. In this position, the door 5 is in the closed position, it closes the access opening 230, and the slide 7 is in the retracted position.

When the operator wishes to carry out a maintenance operation, he stops the operation of the burner 4. He can then, by pulling on the handles 58, cause the slide 7 to slide until it reaches its extended position, shown in FIG. 3. The slide 7 is then moved until its end-of-travel stop 75 comes into abutment against the rollers 81 and 84. The pin 77 is still in place, so that the door 5 remains perpendicular to the slide 7. The door 5 then is then located in a position called “space-apart” (“separated”) in which it is moved away, i.e. separated from the access opening 230.

In addition, the length of the slide 7 and the positioning of its rear stop 75 having been adapted based on the size of the burner 4, this is located completely outside the firebox 30.

The operator then withdraws the pin 77 so as to allow the pivoting movement of the door 5, toward the front of the exchanger 1, around the pivot 6, until the latter is brought to a so-called “returned” position shown in FIG. 4.

In this returned position, the door 5 has pivoted by at least 180°. The burner 4 being previously completely withdrawn from the shell 2, it does not risk entering into collision with the exchange device 3.

Finally, the operator can also push back the door 5, so as to bring the slide 7 into its retracted position and thus achieve the disposition shown in FIG. 5. In this latter position, access to the combustion chamber 30 is total, which facilitates maintenance operations. The same is true for the burner 4 which, when the door 5 has pivoted 180°, is completely accessible.

When the maintenance operations are finished, the operator can then move the door 5 forward, so as to bring the slide 7 into its extended position (FIG. 4), then make the door 5 pivot 180° to bring it back into the spaced-apart position of FIG. 3, block the pin 77 in the port 76, push the door 5 and the slide 7 back so as to bring the slide into its retracted position and the door 5 into its closed position.

Generally, the invention is particularly well suited for a burner 4 of which the size (dimensions in length and in width) is such that the door 5 could not be opened without risk of damaging the device 3 if it was provided with a simple hinge as in the prior art.

1. A heat exchanger (1) comprising a gas-tight shell (2) containing a heat exchange device (3) and delimiting a combustion chamber (30), said shell (2) being provided with an access opening (230) and with a door (5) suitable for being able to close said access opening, said door (5) being provided with a burner (4), particularly for gas or fuel oil, protruding from its inner face (51), characterized in that said door (5) is mounted pivotally around a pivot (6) attached to the so-called “front” end (74) of a slide (7), or substantially to this front end, in that said shell (2) is provided on its exterior surface with guide means (8) which allow said slide (7) to be guided axially along a displacement axis X2-X′2 which extends parallel to the longitudinal axis X-X′ of said shell (2) and in that the pivot (6) extends along an axis Z-Z′ perpendicular to said displacement axis X2-X′2, and in that the travel of said slide (7) is greater than the length of the burner (4), so that said door (5) can be moved from a closed position, in which it closes the access opening (230) of said shell (2), to a so-called “spaced-apart” position, in which it is moved away from this access opening (230) and in which the burner (4) is located outside the shell (2), and said door (5) being able to pivot around the pivot (6) when it is located in said “spaced-apart” position.

2. The heat exchanger according to claim 1, characterized in that the door (5) can pivot around the pivot (6) at an angle of at least 180°.

3. The heat exchanger according to claim 1 or 2, characterized in that the slide (7) is provided with an end-of-travel stop (75) which prevents it from leaving the guide means (8).

4. The heat exchanger according to one of the preceding claims, characterized in that the slide (7) is a strip having an upper face (71) and a lower face (72) and in that the guide means (8) comprise two upper rotating rollers (81, 82) and two lower rotating rollers (83, 84) in the shape of twin wheels, mounted as idlers, provided with a groove (810, 820, 830, 840), the profile of which corresponds to that of said upper (71) and lower (72) faces of the slide.

5. The heat exchanger according to claim 4, characterized in that the upper face (71) and the lower face (72) of the slide have the shape of a protruding V with two facets (711, 712, 721, 722).

6. The heat exchanger according to one of the preceding claims, characterized in that a plate (56) is attached to the outer face (52) of the door (5) and has two protruding flanks (561) which extend in a plane perpendicular to the axis Z-Z′ of the pivot (6), in that each flank (561) is perforated with an aperture (5610), in that the pivot (6) has a blind hole (61) at each of its two ends and in that a shoulder screw (562) is screwed into each blind hole (61) through the aperture (5610) provided in the flank, so as to allow the pivoting of the door (5) around the pivot (6).

7. The heat exchanger according to one of the preceding claims, characterized in that said door (5) is provided with blocking means (77) preventing its pivoting around the pivot (6) with respect to said slide (7) and holding it in a position where it is perpendicular to the displacement axis (X2-X′2) of said slide (7).

8. The heat exchanger according to claim 7, characterized in that the slide (7) is provided at its front end with a port (76) passing through it from side to side, in that the door (5) has at its periphery, on its face situated facing the pivot (6), a blind hole and in that said blocking means comprise a removable pin (77) configured to be able to be inserted through said port (76), into said blind hole, thus blocking the pivoting movement of the door (5) with respect to the slide (7).

9. The heat exchanger according to one of the preceding claims, characterized in that the door (5) is provided with at least one handle (58) on its outer face (52).
